(19) United States
(12) Patent Application Publication
(10) Pub. No.: US 2026/0187236 A1
(43) Pub. Date: Jul. 2, 2026

(54) METHOD, APPARATUS, ELECTRONIC DEVICE AND STORAGE MEDIUM FOR SERVICE REQUEST PROCESSING

(71) Applicant: Lemon Inc., Grand Cayman (KY)

(72) Inventors: Haifan Guo, Los Angeles, CA (US); Xinqi Tang, Beijing (CN); Bolun Wang, Beijing (CN); Hang Xu, Beijing (CN); Qingyue Zhou, Beijing (CN); Yuan Lin, Culver City, CA (US)

(21) Appl. No.: 19/130,510

(22) PCT Filed: Nov. 15, 2023
(86) PCT No.: PCT/SG2023/050763

§ 371 Date: May 15, 2025

(30) Foreign Application Priority Data
Nov. 15, 2022 (CN) 202211431048.9

(51) Int. Cl. G06F 21/55

(52) U.S. Cl. CPC G06F 21/554; G06F 2221/033

(57) ABSTRACT

Methods, apparatuses, electronic devices and storage medium for service request processing are provided. User feedback data for a target service is obtained, wherein the target service is triggered based on a service request link which includes a downstream service node characterizing the target service and an upstream service node characterizing a preceding service of the target service, and the user feedback data indicates the risk of a first service request for the downstream service node; a first training sample is generated based on the user feedback data, which includes a second service request that corresponds to the first service request and is a service request for the upstream service node; and online training is performed on a target risk control model based on the first training sample to obtain an updated target risk control model, the target risk control model identifying a risky service request for the upstream service node.

The present application claims priority to Chinese Patent Application No. 202211431048.9, filed on Nov. 15, 2022 and entitled “METHOD, APPARATUS, ELECTRONIC DEVICE AND STORAGE MEDIUM FOR SERVICE REQUEST PROCESSING”, which is incorporated herein by reference in its entirety.

### FIELD

Embodiments of the present disclosure relate to the field of computer technology, and in particular, to a method, apparatus, electronic device and storage medium for service request processing.

### BACKGROUND

At present, with the rapid development of the Internet industry, risky acts such as cyberattacks, information theft, extortion and fraud committed using Internet technology are also on the rise. Various Internet platforms usually set up risk control mechanisms to intercept such risky service requests to ensure the security of content and information in the platforms.

In the prior art, with regard to a large number of risky service requests, a platform usually performs automatic interception based on a pre-trained risk control model; however, in an actual application process, the risk control model has the problems of low interception efficiency and poor interception timeliness.

### SUMMARY

The embodiments of the present disclosure provide a method, apparatus, an electronic device, and a storage medium for service request processing, so as to overcome problems of low interception efficiency and poor accuracy of a risk control model.

In a first aspect, an embodiment of the present disclosure provides a method of service request processing, comprising:
obtaining user feedback data for a target service, wherein the target service is triggered based on a corresponding service request link, the service request link comprises a downstream service node and an upstream service node, the downstream service node characterizes the target service, the upstream service node characterizes a preceding service of a target service, and the user feedback data indicates the risk of a first service request for the downstream service node;
generating a first training sample based on the user feedback data, the first training sample comprising a second service request corresponding to the first service request, the second service request being a service request for the upstream service node; and training a target risk control model based on the first training sample to obtain an updated target risk control model, wherein the target risk control model identifies a risky service request for the upstream service node.

In a second aspect, an embodiment of the present disclosure provides a service request processing apparatus, comprising:
an obtaining module, configured to obtain user feedback data for a target service, wherein the target service is triggered based on a corresponding service request link, the service request link comprises a downstream service node and an upstream service node, the downstream service node characterizes the target service, the upstream service node characterizes a preceding service of a target service, and the user feedback data indicates the risk of a first service request for the downstream service node;
a generating module, configured to generate a first training sample based on the user feedback data, the first training sample comprising a second service request corresponding to the first service request, the second service request being a service request for the upstream service node; and
a training module, configured to train a target risk control model based on the first training sample to obtain an updated target risk control model, wherein the target risk control model identifies a risky service request for the upstream service node.

In a third aspect, an embodiment of the present disclosure provides an electronic device, comprising:
a processor and a memory that is in communication connection with the processor; wherein
the memory stores computer-executed instructions;
the processor executes the computer-executed instructions stored in the memory so as to implement the method of service request processing according to the first aspect and various possible designs of the first aspect.

In a fourth aspect, an embodiment of the present disclosure provides a computer-readable storage medium, wherein the computer-readable storage medium stores computer-executed instructions which, when executed by a processor, implement the method of service request processing according to the first aspect and various possible designs of the first aspect.

In a fifth aspect, an embodiment of the present disclosure provides a computer program product, comprising a computer program, wherein the computer program, when executed by a processor, implements the method of service request processing according to the first aspect and various possible designs of the first aspect.

### BRIEF DESCRIPTION OF THE DRAWINGS

In order to more clearly illustrate the technical solutions in the embodiments of the present disclosure or related technologies, the accompanying drawings used in the description of the embodiments or related technologies are briefly introduced below. It is obvious that the drawings in the following description are some embodiments of the present disclosure, and those of ordinary skill in the art may further derive other drawings from these drawings without the exercise of any inventive effort.

FIG. 1 is an application scenario diagram of a method of service request processing according to an embodiment of the present disclosure;

FIG. 2 is a first flowchart of a method of service request processing according to an embodiment of the present disclosure;

FIG. 3 is a schematic diagram of a service request link according to an embodiment of the present disclosure;

FIG. 4 is a flowchart of specific implementation steps of step S103 in the embodiment shown in FIG. 2;

FIG. 5 is a schematic diagram of a process of updating a target risk control model according to an embodiment of the present disclosure;

FIG. 6 is a second flowchart of a method of service request processing according to an embodiment of the present disclosure;

FIG. 7 is a schematic diagram of a target service feature set according to an embodiment of the present disclosure;

FIG. 8 is a flowchart of specific implementation steps of step S205 in the embodiment shown in FIG. 6;

FIG. 9 is a schematic diagram of a confidence weight according to an embodiment of the present disclosure;

FIG. 10 is a schematic diagram of a process of obtaining a first data set according to an embodiment of the present disclosure;

FIG. 11 is a structural block diagram of a service request processing apparatus according to an embodiment of the present disclosure;

FIG. 12 is a schematic structural diagram of an electronic device according to an embodiment of the present disclosure; and

FIG. 13 is a schematic diagram of a hardware structure of an electronic device according to an embodiment of the present disclosure.

### DETAILED DESCRIPTION

In order to make the objectives, technical solutions and advantages of the embodiments of the present disclosure more apparent, the technical solutions in the embodiments of the present disclosure will be clearly and completely described below with reference to the accompanying drawings in the embodiments of the present disclosure. It is obvious that the embodiments to be described are merely part not all of the embodiments of the present disclosure. All other embodiments obtained by those skilled in the art based on the embodiments of the present disclosure without creative efforts shall fall within the scope of the present disclosure.

An application scenario of the embodiments of the present disclosure will be explained below:

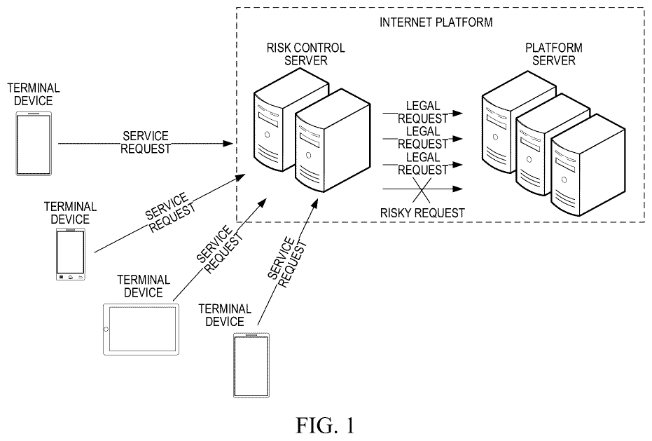

FIG. 1 is a diagram of an application scenario of a method of service request processing provided in an embodiment of the present disclosure. The method of service request processing provided in the embodiment of the present disclosure can be applied to an application scenario of security protection and risk control management of an Internet platform, and more specifically, to an application scenario of security protection of a social platform. Exemplarily, the method provided in the embodiment of the present disclosure can be applied to a risk control server. In a possible implementation, as shown in FIG. 1, a risk control server is connected to a platform server; an external request sent by a terminal device first enters the risk control server; a risk control model deployed in the risk control server detects the external request, intercepts a risky request therein and sends a normal legal request to the platform server; the platform server responds to the legal request, generating platform content such as user messages and posting information.

At present, with the rapid development of the Internet industry, risky acts such as cyberattacks, information theft, extortion and fraud committed using Internet technology are also increasing, for example, including promoting risky websites and posting fraud information on Internet social networking platforms, so as to obtain risky gains. The foregoing risky acts are generally committed by automatically sending a service request to a platform server by using a computer script, thereby registering accounts on Internet social networking platforms in batches and posting risky content under the guise of real users. In the prior art, with regard to a large number of risky service requests, the platform usually performs automatic interception based on a pre-trained risk control model. However, an interception solution in the prior art usually intercepts the risky service requests themselves. Such a method, on the one hand, results in a strong perception of risky attackers, thus bypassing the interception by changing the parameters, making the risk control model ineffective and the interception efficiency and timeliness poor. On the other hand, there is a problem that it is difficult to obtain a sufficient number of training samples to optimize the risk control model, resulting in a poor generalization ability of the risk control model and a low interception accuracy rate.

Embodiments of the present disclosure provide a method of service request processing to solve the above problems.

By means of the method, apparatus, electronic device and storage medium for service request processing provided by the embodiments, user feedback data for a target service is obtained, wherein the target service is triggered based on a corresponding service request link, the service request link comprises a downstream service node and an upstream service node, the downstream service node characterizes the target service, the upstream service node characterizes a preceding service of the target service, and the user feedback data indicates the risk of a first service request for the downstream service node; a first training sample is generated based on the user feedback data, wherein the first training sample comprises a second service request corresponding to the first service request, and the second service request is a service request for the upstream service node; and online training is performed on a target risk control model based on the first training sample to obtain an updated target risk control model, wherein the target risk control model identifies a risky service request for the upstream service node. On the service request link corresponding to the target service, the service request corresponding to the downstream service node can better reflect the intention of the service request, and the data value is higher. By utilizing the logical relationship between the downstream service node and the upstream service node on the business request link, the corresponding first training sample is generated through the user feedback data, and the risk control model is trained, so that the trained risk control model can learn a feature generated based on high-quality information in the user feedback data, Thus, accurate identification of a risky service request corresponding to the upstream service node is realized, and the interception rate and interception time-effectiveness of the risk control model are improved.

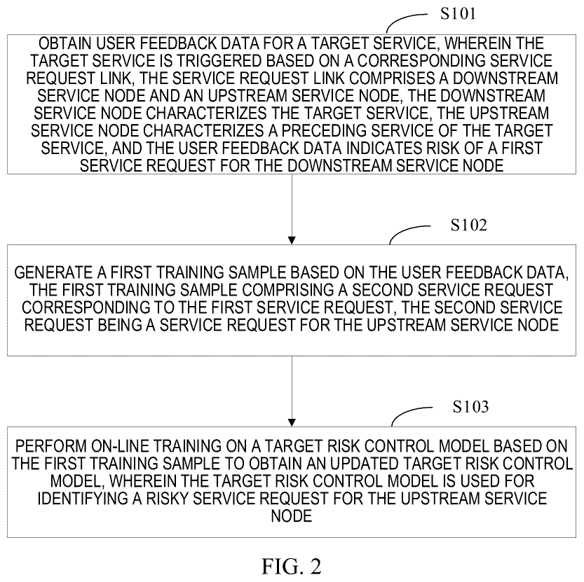

Referring to FIG. 2, this figure is a first schematic flowchart of a method of service request processing according to an embodiment of the present disclosure. The method in this embodiment may be applied to a server. The method of service request processing comprises:

Step S101: obtaining user feedback data for a target service, wherein the target service is triggered based on a corresponding service request link, the service request link comprises a downstream service node and an upstream service node, the downstream service node characterizes the target service, the upstream service node characterizes a preceding service of the target service, and the user feedback data indicates the risk of a first service request for the downstream service node.

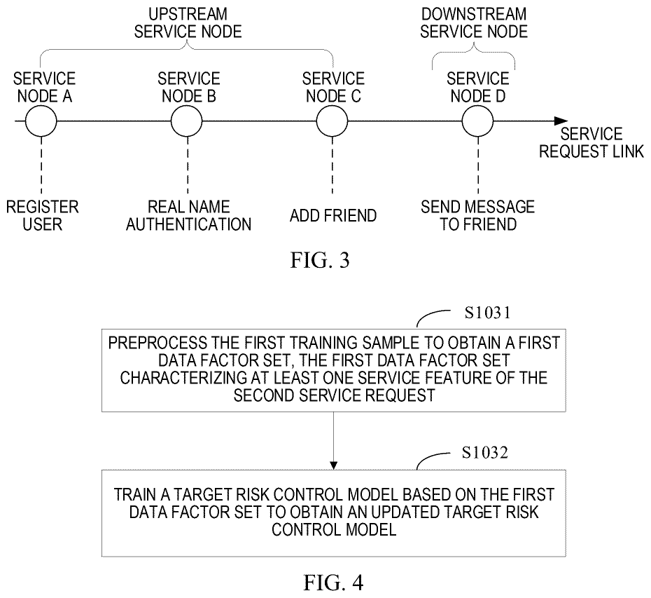

Exemplarily, the execution body of this embodiment is, for example, a risk control server, which communicates with a server of an Internet platform; the target service refers to a function service on the Internet platform, such as “message”, “post”, “information”, etc. The target service implemented on the Internet platform generally has The target business realized on the Internet platform usually has ordered preceding services, and can be triggered only after service requests corresponding to the preceding services are executed in order. The set of ordered service requests corresponding to the target service is a service request link. The service request link consists of service nodes. The service request link comprises a downstream service node and an upstream service node. The downstream service node characterizes the target service, and the upstream service node represents a preceding service of the target service. FIG. 3 is a schematic diagram of a service request link provided in an embodiment of the present disclosure. As shown in FIG. 3, the service request link consists of four sequentially-executed service nodes, which are respectively a service node A, a service node B, a service node C and a service node D. The service node A characterizes a service as “register user”, the service node B characterizes a service as “real name authentication”, the service node C characterizes a service as “add friend”, and the service node D characterizes a service as “send message to friend”. The service node D is a downstream service node, and a service corresponding thereto “send message to friend” is a target service, i.e., an information service. To implement the information service, corresponding preceding services need to be completed, that is, “register user” corresponding to the service node A, “real name authentication” corresponding to the service node B, and “add friend” corresponding to the service node C. The service node A, the service node B, and the service node C are upstream service nodes corresponding to the downstream service node, and the service corresponding to respective upstream service nodes are preceding services.

Further, the risk control server obtains, by communicating with a server of an Internet of Things platform, relevant data for feeding back an risk control problem and submitted by a user through an application client, that is, user feedback data. More specifically, the user feedback data is, for example, appeal data, complaint data, etc., wherein, for example, the appeal data refers to appeal information which is submitted to an Internet platform after a service request sent by a user is intercepted; the complaint data refers to report information of risky service information (such as risky advertisement and fraud information) submitted by the user to the Internet platform. After intercepting the sent service request, the appeal information is sent to the Internet platform. With the user feedback data, the risk of the first service request with regard to a downstream service node on the Internet platform can be identified, and more specifically, the first service request is a service request sent with regard to the target service, and comprises specific requested content and relevant information. For example, the target service (downstream service node) is an information service, and the first service request includes information such as information content, information sending time, and an information sender identifier. With the user feedback data, the information data (the first service request) may be marked as a legal request or a risky request. If the user feedback data is complaint data, the first service request is marked as a risky request as a positive sample in the subsequent risk control model training process; if the user feedback data is appeal data, then the first service request is marked as a legal request as a negative sample in the subsequent risk control model training process.

The user feedback data is pre-stored in a server of the Internet platform, and the risk control server extracts the user feedback data based on a fixed time interval, or based on the amount of the user feedback data. The user feedback data may be data obtained by filtering original feedback data uploaded by the user based on manual or other models and steps, so as to ensure the validity and authenticity of the user feedback data.

Step S102: based on the user feedback data, generating a first training sample, wherein the first training sample comprises a second service request corresponding to the first service request, and the second service request is a service request for the upstream service node.

Exemplarily, after the user feedback data is obtained, based on the risk of the first service request of the downstream service node indicated by the user feedback data, a corresponding positive sample or negative sample is generated, i.e., a first training sample, the first training sample comprising a service request for at least one upstream service node corresponding to the downstream service node, for example, a service request sent to a preceding service such as “register user” and “add friend” (an upstream service node) corresponding to the “information service” (a downstream service node). The first training sample, for example, includes information such as “user name”, “registration time”, and “friend identifier”. Based on the first training sample, a target risk control model can be trained, so that the target risk control model learns service request features of risky service requests and legal service requests of upstream service nodes corresponding to downstream service nodes indicated by the user feedback data, thereby identifying risky service requests of the upstream service nodes.

In the process of the user (via a terminal device) sending service requests to a server (of an Internet of Things platform), the risk control server obtains and records various service requests, and stores the same in the form of a service request link, so as to form a unique record identifier. After the user feedback data is obtained, based on the first service request for a downstream service node and indicated by the user feedback data, a corresponding target record identifier is determined, and based on a target service request link corresponding to the target record identifier, a second service request corresponding to the first service request is obtained.

Step S103: performing on-line training on a target risk control model based on the first training sample to obtain an updated target risk control model, wherein the target risk control model identifies a risky service request for the upstream service node.

Further, after obtaining the first training sample, based on the specific implementation of the user feedback data (complaint data or appeal data), the first training sample is used as a positive sample (complaint data) or a negative sample (appeal data) to train a target risk control model, enabling the target risk control model to learn service request features of a risky service request and a legal service request of an upstream service node corresponding to the downstream service node indicated by user feedback data. After receiving an online service request for the upstream service node, the target risk control model may be identify the online service request based on a trained model structure, and intercept the online service request after the online service request is identified as an risky service request. Thus, front-end interception of risky service requests is realized, the interception efficiency is improved, and moreover, the problem of low identification efficiency of a risky service request for an upstream service node where a risky service initiator modifies a script parameter is solved.

In a possible implementation, as shown in FIG. 4, a specific implementation of step S103 comprises:

Step S1031: preprocessing the first training samples to obtain a first data factor set, wherein the first data factor set characterizes at least one service feature of the second service request.

Step S1032: training a target risk control model based on the first data factor set, so as to obtain an updated target risk control model.

Exemplarily, after the first training sample is obtained, the first training sample is pre-processed, and a set of service features of the second service request corresponding to the first training sample, that is, a first data factor set, is extracted. In a process of judging the risk of a service request, the target risk control model makes judgment based on a service feature of each service request. The service feature includes, for example, various parameters such as a specific service initiation time and service content. Then, the target risk control model is trained based on the first data factor set, so that the target risk control model can learn service features (i.e. risky service features) of risky service requests, thereby realizing the update of the target risk control model.

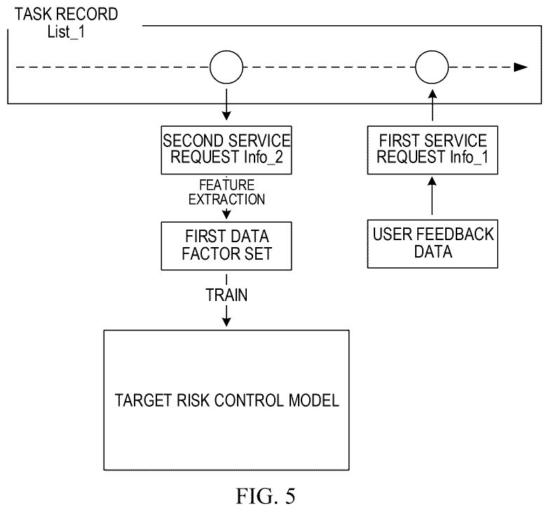

FIG. 5 is a schematic diagram of a process of updating a target risk control model according to an embodiment of the present disclosure. The foregoing process is introduced in detail with reference to FIG. 5. As shown in FIG. 5, exemplarily, the user feedback data includes complaint data of a first service request Info_1 for an information service. Based on the first service request Info_1, a corresponding task record List_1 is determined, wherein the task record List 1 records, in the form of a service request link, a second service request Info_2 of an upstream service node corresponding to the “information service”; then feature extraction is performed on the second service request Info_2 to obtain a first data factor set; and a target risk control module is trained based on the first data factor set.

Exemplarily, after completing the training step for the target risk control model, the procedure returns to step S101 to cyclically perform the above steps, so as to implement continuous iterative optimization of the target risk control model.

In this embodiment, user feedback data for a target service is obtained, wherein the target service is triggered based on a corresponding service request link, the service request link comprises a downstream service node and an upstream service node, the downstream service node characterizes the target service, the upstream service node characterizes a preceding service of the target service, and the user feedback data indicates the risk of a first service request for the downstream service node; a first training sample is generated based on the user feedback data, wherein the first training sample comprises a second service request corresponding to the first service request, and the second service request is a service request for the upstream service node; and online training is performed on a target risk control model based on the first training sample to obtain an updated target risk control model, wherein the target risk control model identifies a risky service request for the upstream service node. On the service request link corresponding to the target service, the service request corresponding to the downstream service node can better reflect the intention of the service request, and the data value is higher. By utilizing the logical relationship between the downstream service node and the upstream service node on the business request link, the corresponding first training sample is generated through the user feedback data, and the risk control model is trained, so that the trained risk control model can learn a feature generated based on high-quality information in the user feedback data, Thus, accurate identification of a risky service request corresponding to the upstream service node is realized, and the interception rate and interception time-effectiveness of the risk control model are improved.

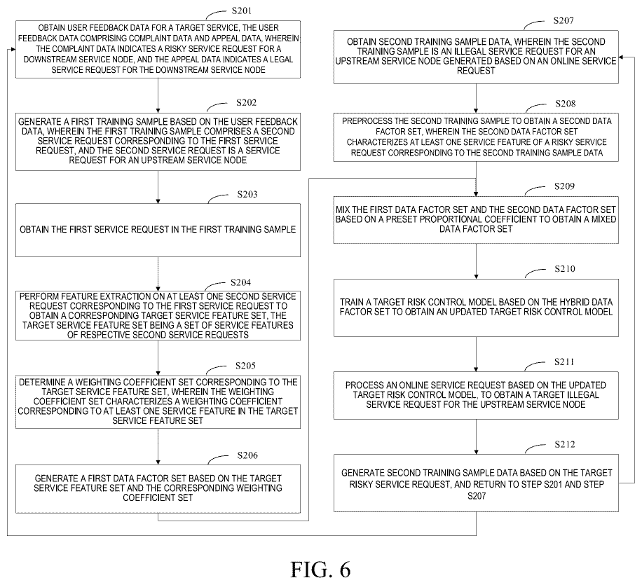

Referring to FIG. 6, this figure is a second flowchart of a method of service request processing according to an embodiment of the present disclosure. On the basis of the embodiment shown in FIG. 2, this embodiment further refines step S103, and the method of service request processing comprises:

Step S201: obtaining user feedback data for a target service, the user feedback data comprising complaint data and appeal data, wherein the complaint data indicates a risky service request for a downstream service node, and the appeal data indicates a legal service request for the downstream service node.

Step S202: generating a first training sample based on the user feedback data, wherein the first training sample comprises a second service request corresponding to the first service request, and the second service request is a service request for an upstream service node.

Exemplarily, after obtaining the user feedback data, a corresponding positive sample and/or negative sample is generated according to specific content of the user feedback data. Specifically, for example, a positive sample is generated based on the complaint data indicating the risky service request for the downstream service node; a negative sample is generated based on appeal data indicating the legal service request for the downstream service node. The specific implementation process has been introduced in the embodiment shown in FIG. 2, and is repeated herein. Afterwards, the first training sample is generated according to the positive sample, the negative sample, or a set of the positive sample and the negative sample.

Step S203: obtaining the first service request in the first training sample.

Step S204: performing feature extraction on at least one second service request corresponding to the first service request, so as to obtain a corresponding target service feature set, the target service feature set being a set of service features of respective second service requests.

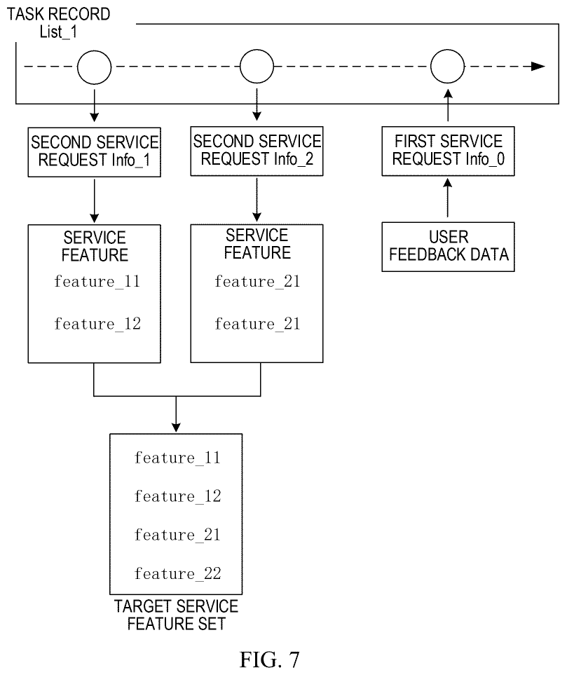

Exemplarily, the first service request corresponding to the user feedback data is a risky service request for a downstream service node. By parsing and processing the user feedback data, the first service request corresponding to the user feedback data can be obtained. In addition, based on the service request link to which the downstream service node corresponding to the first service request belongs, the second service request corresponding to the user feedback data may be further determined. Then, feature extraction is performed on the second service request to obtain a feature of the second service request, wherein there may be one or more second service requests corresponding to the user feedback data, and each second service request may comprise one or more service features. FIG. 7 is a schematic diagram of a target service feature set according to an embodiment of the present disclosure. As shown in FIG. 7, the first service request Info_0 is a historical risky service request determined based on the user feedback data (for example, complaint data fed back by the user); according to the task record List_1 corresponding to the first service request Info_0, a service request corresponding to the upstream service node corresponding to the first service request is obtained, that is, the second service request Info_1 and the second service request Info_2 whose execution timing sequence is as shown in the figure; then, a set of service features corresponding to the second service request Info_1 and the second service request Info_2 is extracted, to obtain a target service feature set. Specifically, for example, the second service request corresponding to the first service request comprises: the second service request Info_1 and the second service request Info_2, wherein an upstream service node corresponding to the second service request Info_1 is “register user”, an upstream service node corresponding to the second service request Info_2 is “user login”, and service features of the second service request Info_1 comprise:
feature_11: registration time is 4-5.
feature_12: the length of a registration name is 8-10 characters.
Service features of the second service request Info_2 comprise:
feature_21: login time is 4-5 o'clock.
feature_22: the login site is “unknown” or “overseas”.

Then, the respective service features of the second service request Info_1 and the second service request Info_2 are merged to obtain the target service feature set={[Info_1: feature_11, feature_12], [Info_2: feature_21, feature_22]}.

The data structure of the target service feature set in the foregoing example is only exemplary, and a specific implementation may be set according to requirements, which are not repeatedly described herein by way of example.

Step S205: determining a weighting coefficient set corresponding to the target service feature set, wherein the weighting coefficient set characterizes a weighting coefficient corresponding to at least one service feature in the target service feature set.

Exemplarily, after obtaining the target service feature set, a weight of each service feature in the target service feature set is further determined. For example, referring to a schematic diagram of the target service feature set shown in FIG. 7, a weight corresponding to feature_11 is, for example, w1, a weight corresponding to feature_12 is, for example, w2, a weight corresponding to feature_21 is, for example, w3, and a weight corresponding to feature_22 is, for example, w4. A set of respective weights, for example, [w1, w2, w3, w4], is a weighting coefficient set. A weighting coefficient in the weighting coefficient set is an influence factor when a service feature judges an invalid service request, and characterizes an influence degree when judging a risky service request. In a possible implementation, a weighting coefficient in the weighting coefficient set characterizes a training weight when judging a risky service request, that is, the larger (absolute value) the weighting coefficient, the larger impact on a judgment result. In another possible implementation, the weighting coefficient in the weighting coefficient set characterizes an adjustment amount of an original training weight when judging a risky service request. That is, on the basis of the original training weight, the original training weight is adjusted based on the weighting coefficient in the weighting coefficient set. The larger the weighting coefficient (absolute value), the larger the change amount of the original training weight. Then, the risky service request is judged based on the adjusted training weight.

Further, exemplarily, the weighting coefficient set comprises a positive weighting coefficient and a negative weighting coefficient, wherein the negative weighting coefficient is generated based on appeal data, and the positive weighting coefficient is generated based on complaint data. The positive weighting coefficient is used for generating a positive sample to train the target risk control model, and the negative weighting coefficient is used for generating a negative sample to train the target risk control model.

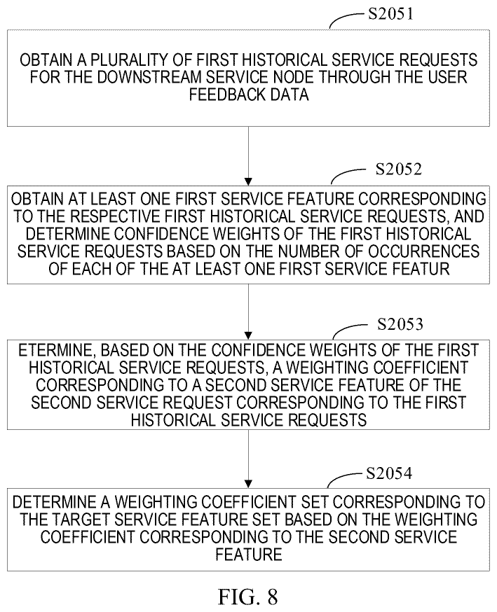

In a possible implementation, as shown in FIG. 8, specific implementation steps of step S205 comprise:

Step S2051: obtaining a plurality of first historical service requests for the downstream service node through the user feedback data.

Step S2052: obtaining at least one first service feature corresponding to the respective first historical service requests, and determining confidence weights of the first historical service requests based on the number of occurrences of each of the at least one first service feature.

Step S2053: determining, based on the confidence weights of the first historical service requests, a weighting coefficient corresponding to a second service feature of the second service request corresponding to the first historical service requests.

Step S2054: determining a weighting coefficient set corresponding to the target service feature set based on the weighting coefficient corresponding to the second service feature.

Exemplarily, first, a historical service request of the downstream service node, that is, a first historical service request, is obtained through the user feedback data. Based on a specific implementation of the user feedback data, the user feedback data request may be historical complaint data or history appeal data. Accordingly, the generated first historical service request characterizes a historical risky service request or a historical legal service request for the downstream service node. Then, based on a related historical record of each first historical service request in the database (the user feedback data comprises a plurality of groups of data, each group of data corresponding to an obtained first historical service request), at least one first service feature corresponding to each first historical service request is obtained, wherein among the plurality of first service features obtained above, there will be repetitive service features, and based on the repetition of the first service feature, at this point, a confidence level of the corresponding first historical business request can be determined

The specific implementation step of determining a confidence weight of the first historical service request according to the number of occurrences of each first service feature in step S2053 comprises:

Step S2053A: obtaining a first quantity and a second quantity, wherein the first quantity characterizes a total number of features of the respective first service features corresponding to the user feedback data; the second quantity characterizes a cumulative sum of the number of respective first service features corresponding to the first historical service request which recur among respective first service features corresponding to the user feedback data.

Step S2053B: determining a confidence weight of the first historical service request according to a proportional relationship between the second quantity and the first quantity.

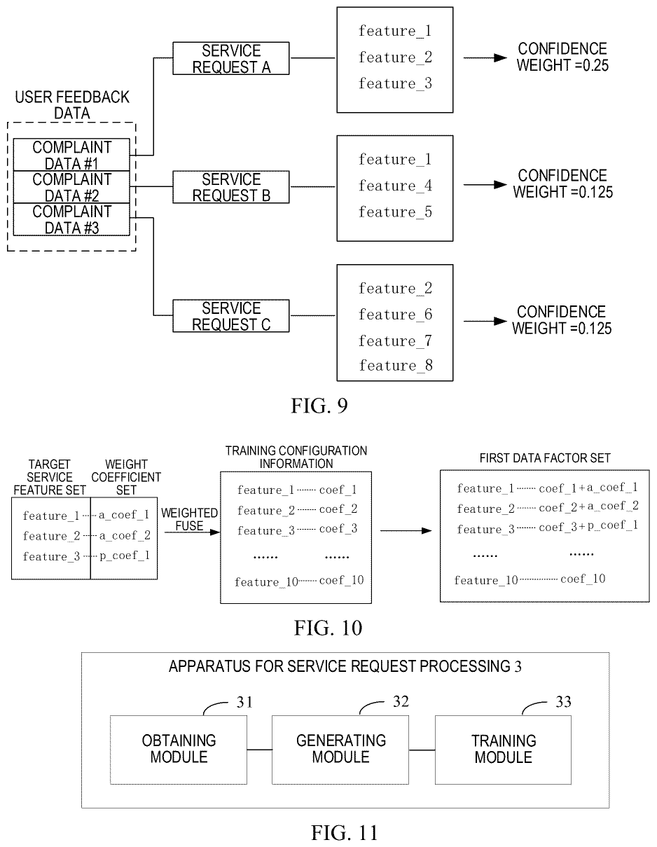

For example, FIG. 9 is a schematic diagram of a confidence weight according to an embodiment of the present disclosure. As shown in FIG. 9, exemplarily, the user feedback data comprises three groups of data, complaint data #1, complaint data #2 and complaint data #3, respectively, each group of complaint data corresponding to one first historical service request, i.e., service request A, service request B and service request C, wherein the service request A comprises feature_1, feature_2 and feature_3 in the first service feature; the service request B comprises feature 1, feature 4 and feature 5 in the first service feature; the service request C comprises feature 2, feature_6, feature_7 and feature_8 in the first service feature. A confidence weight of the first historical service request is calculated according to the number of occurrences of each first service feature. One possible method for calculating the confidence weight is as shown in Formula (1):

$$weight ( n ) = {\sum }_{i = 1}^{feature \_ N ( n )} ( {feature}_{rep} ( i ) - 1 ) \times coef \div N \qquad ( 1 )$$

wherein weight(n) is the nth first historical service request, feature_{N(n)} is the number of first service features corresponding to the nth first historical service request; featureᵣₑₚ(i) is the number of times that the i^{th} first service feature is repeated in all the first service features; coefis an adjustment coefficient, which can be flexibly set according to needs; N is the number of all the first service features.

Based on Formula (1), the value of coef is 1, the confidence weight of the service request A is (1+1+0)×1÷8=0.125. Similarly, the confidence weight of the service request B is (1+0+0)×1÷8=0.125, and the confidence weight of the service request C is (1+0+0+0)×1÷8=0.125.

Then, the confidence weight corresponding to the first historical service request is weighted based on the corresponding relationship between the first historical service request and the second historical service request, and then is transferred to the corresponding second historical service request. For example, the confidence weight of the first historical service request A is 0.25; if the confidence weight of the first historical service request B is 0.125, then the confidence weight 0.25 of the first historical service request A is transferred to the respective service features corresponding to the first historical service request A, so that the weighting coefficient of each service feature corresponding to the first historical service request A is 0.25. In this way, the feature transfer of the risky service request corresponding to the downstream service node is realized. Afterwards, based on the weighting coefficients corresponding to the respective second service features, the same weighting coefficients are merged if there are, and finally, a weighting coefficient set corresponding to the target service feature set is generated.

In this embodiment, considering that a risky attacker makes a risky service request by using a computer script, by calculating a confidence weight of each first historical service request, a service feature repeatedly appearing in the complaint data or appeal data is obtained, thereby determining a first historical service request (user feedback data) with high credibility based on the repeatability of service features in respective historical service requests. Then, based on the first historical service request of the credibility obtained in the step of this embodiment, the corresponding second service history request is weighted, and model training is performed based on the weighted second historical service request, so that the target risk control model fully learns a training sample corresponding to the high-quality downstream service node, and the training quality of the target risk control model is improved.

Step S206: generating a first data factor set according to the target service feature set and the corresponding weighting coefficient set.

Exemplarily, after obtaining the target service feature set and the corresponding weighting coefficient set, in a possible implementation, the target service feature set and the corresponding weighting coefficient set are directly used as the first data factor set, wherein the first data factor set is training configuration information in the target risk control model. When the target risk control model is trained for the first time, the target service feature set and the corresponding weighting coefficient set (the first data factor set) are taken as initial training configuration information in the target risk control model. When training the target risk control model based on the initial training configuration information, a weight of a service feature corresponding to each second service request in a training sample is determined based on the first data factor set. When the target risk control model is not trained for the first time, current training configuration information in the target risk control model is updated based on the target service feature set and the corresponding weighting coefficient set, so as to obtain updated training configuration information, i.e., the first data factor set.

Exemplarily, specific implementation steps of step S206 comprise:
Step S2061: obtaining training configuration information, wherein the training configuration information is a weighting coefficient for a service feature corresponding to the second service request in a training sample in a training process of the target risk control model;
Step S2062: based on the target service feature set and the corresponding weighting coefficient set, performing weighted fusion on training weights of corresponding invalid service features in the training configuration information to obtain a first data factor set, and updating the training configuration information into the first data factor set.

Exemplarily, FIG. 10 is a schematic diagram of a process of obtaining a first data set according to an embodiment of the present disclosure. As shown in FIG. 10, current training configuration information includes service features feature 1 to feature_10 and weighting coefficients coef_1 to coef_10 corresponding to the respective service features. After a corresponding target service feature set and a corresponding weighting coefficient set are obtained through the user feedback data, the target service feature set comprises [feature_1, feature_2, feature_3], and the corresponding weighting coefficient set comprises weighting coefficients [a_coef_1, a_coef_2, and p_coef_3] corresponding to feature_1, feature_2, and feature_3, wherein a_coef_1, a_coef_2 are positive weighting coefficients (positive numbers), and p_coef_3 is negative weighting coefficients (negative numbers). After performing weighted fusion on the training configuration information, the target service feature set and the corresponding weighting coefficient set (exemplarily, a weighting coefficient being taken as 1), a first data factor set is obtained, and then the training configuration information is updated into the first data factor set, thereby realizing the update of weighting coefficients of service features feature_1, feature_2 and feature_3 in the training configuration information.

Step S207: obtaining second training sample data, wherein the second training sample is a risky service request for an upstream service node generated based on an online service request.

Step S208: preprocessing the second training sample to obtain a second data factor set, wherein the second data factor set characterizes at least one service feature of a risky service request corresponding to the second training sample data.

Step S209: mixing the first data factor set and the second data factor set according to a preset proportional coefficient to obtain a hybrid data factor set.

Exemplarily, on the other hand, while performing online training on the model, an online service request obtained by an internet platform is obtained, that is, a service request generated when the user normally uses the internet platform. Then, the online service request is processed to identify a risky service request for an upstream service node therein, so as to obtain second training sample data. Specifically, for example, the online service request may be processed using a model dedicated to identify a risky service request of an upstream service node, so as to obtain second training sample data. For another example, the online service request is processed using the target risk control model, so as to obtain the second training sample data, which may be set according to requirements.

Afterwards, pre-processing is performed on the second training sample, a service feature of a risky service request corresponding to the second training sample is extracted, and a second data factor set is generated. For a method for obtaining the second data factor set, reference may be made to the process of obtaining the first data factor set. The process has been described in detail in the embodiments shown in FIGS. 2 and 6, and details are not repeated herein. Then, based on a preset proportional coefficient, the first data factor set and the second data factor set are mixed to obtain a mixed data factor set. For example, mixing is performed at a ratio of 1 to 5, so as to obtain a mixed data factor set in which the number of the first data factor set and the number of the second data factor set are 1 to 5. Although the data quality of the user feedback data is better, the amount is limited; in order to further improve the training effect of the target data model and increase the generalization ability of the model, obtained first data factor sets and second data factor sets can be mixed according to a certain number proportion, and the weighting coefficients in the first data factor set and the second data factor set are weighted based on pre-set mixed weighting coefficients. For example, the mixed weight of the weighting coefficient in the first data factor set is 0.9, and the mixed weight of the weighting coefficient in the second data factor set is 0.1. Thus, the strength of feature learning in the high-quality first data factor set is improved, and the recognition accuracy of the target risk control model is ensured, and at the same time, the generalization ability of the target risk control model is also taken into account by mixing the second data factor set.

Step S210: training a target risk control model based on the hybrid data factor set to obtain an updated target risk control model.

Step S211: processing an online service request based on the updated target risk control model, to obtain a target risky service request for the upstream service node.

Step S212: generating second training sample data based on the target risky service request, and returning to step S201 and step S207.

Exemplarily, after training a target risk control model to obtain an updated target risk control model, an online service request is continuously processed using the updated target risk control model, an obtained target risky service request for the upstream service node is saved as second training sample data, and then the flow returns to step S201 to repeat the foregoing process. When performing step S207 in the subsequent loop process, second training sample data for generating the second data factor set may be obtained through the second training sample data generated in this step, so as to achieve the purpose of on-line iterative training of the target risk control model. By means of the above steps, in an on-line iterative training process of the target risk control model, by continuously mixing the first data factor set corresponding to the user feedback data and the second data factor set corresponding to the on-line service request, a hybrid data factor set is obtained, and a target risk control model is trained, so that the target risk control model can dynamically identify a risky service request for the upstream service node. Thus, the interception time effectiveness and accuracy of a risky service request can be improved, a risk attacker is difficult to perceive a particular node intercepting same, and further the difficulty and cost of circumventing the interception are increased.

In this embodiment, implementations of step S201, step S202, and step S210 are the same as implementations of step S101, step S102, and step S103 in the embodiment shown in FIG. 2 of the present disclosure, which are not repeated herein.

Corresponding to the method of service request processing in the above embodiments, FIG. 11 is a structural block diagram of a service request processing apparatus according to an embodiment of the present disclosure. For ease of description, only parts related to the embodiments of the present disclosure are shown. Referring to FIG. 11, the service request processing apparatus 3 comprises:
an obtaining module 31, configured to obtain user feedback data for a target service, wherein the target service is triggered based on a corresponding service request link, the service request link comprises a downstream service node and an upstream service node, the downstream service node characterizes the target service, the upstream service node characterizes a preceding service of a target service, and the user feedback data indicates the risk of a first service request for the downstream service node;
a generating module 32, configured to generate a first training sample based on the user feedback data, the first training sample comprising a second service request corresponding to the first service request, the second service request being a service request for the upstream service node; and
a training module 33, configured to perform on-line training on a target risk control model based on the first training sample to obtain an updated target risk control model, wherein the target risk control model identifies a risky service request for the upstream service node.

In an embodiment of the present disclosure, the training module 33 is specifically configured to: preprocess the first training sample to obtain a first data factor set, the first data factor set characterizing at least one service feature of the second service request; and train a target risk control model based on the first data factor set to obtain an updated target risk control model.

In an embodiment of the present disclosure, when pre-processing the first training samples to obtain a first data factor set, the training module 33 is specifically configured to: obtain a first service request corresponding to the user feedback data; perform feature extraction on at least one second service request corresponding to the first service request to obtain a corresponding target service feature set, the target service feature set being a set of service features of the respective second service requests; determine a weighting coefficient set corresponding to the target service feature set, wherein the weighting coefficient set characterizes a weighting coefficient corresponding to at least one service feature in the target service feature set; and generate the first data factor set according to the target service feature set and the corresponding weighting coefficient set.

In an embodiment of the present disclosure, when determining a weighting coefficient set corresponding to the target service feature set, the training module 33 is specifically configured to: obtain a plurality of first historical service requests for the downstream service node by means of the user feedback data; obtain at least one first service feature corresponding to the respective first historical service requests, and determine a confidence weight of the first historical service request according to the number of occurrences of the respective first service feature; determine, according to the confidence weight of the first historical service request, a weighting coefficient corresponding to a second service feature of the second service request corresponding to the first historical service request; and determine a weighting coefficient set corresponding to the target service feature set according to the weighting coefficient corresponding to the second service feature.

In an embodiment of the present disclosure, when determining a confidence weight of the first historical service request according to the number of occurrences of the respective first service feature, the training module 33 is specifically configured to: obtain a first quantity and a second quantity, wherein the first quantity characterizes a total number of features of the respective first service features corresponding to the user feedback data; the second quantity characterizes a cumulative sum of the number of respective first service features corresponding to the first historical service request which recur among respective first service features corresponding to the user feedback data; determine a confidence weight of the first historical service request according to a proportional relationship between the second quantity and the first quantity.

In an embodiment of the present disclosure, the user feedback data comprises complaint data and appeal data, wherein the complaint data indicates a risky service request for the downstream service node, and the appeal data indicates a legal service request for the downstream service node; the weighting coefficient set comprises a positive weighting coefficient and a negative weighting coefficient, the negative weighting coefficient being generated based on the appeal data, and the positive weighting coefficient being generated based on the complaint data.

In an embodiment of the present disclosure, when generating the first data factor set according to the target service feature set and the corresponding weighting coefficient set, the training module 33 is specifically configured to: obtain training configuration information, the training configuration information being a weighting coefficient with respect to a service feature corresponding to the second service request in a training sample in a training process of the target risk control model; perform weighted fusion on training weights of corresponding risky service features in the training configuration information based on the target service feature set and the corresponding weighting coefficient set to obtain a first data factor set, and update the training configuration information with the first data factor set.

In an embodiment of the present disclosure, the generating module 32 is further configured to: obtain second training sample data, the second training sample being a risky service request for an upstream service node generated based on an online service request; the training module 33 is further configured to: pre-process the second training samples to obtain a second data factor set, the second data factor set characterizing at least one service feature of a risky service request corresponding to the second training sample data; mix the first data factor set and the second data factor set according to a preset proportional coefficient to obtain a mixed data factor set; when training a target risk control model based on the first data factor set to obtain an updated target risk control model, the training module 33 is specifically configured to: train the target risk control model based on the mixed data factor set to obtain the updated target risk control model.

In an embodiment of the present disclosure, after performing on-line training on a target risk control model based on the first training samples to obtain an updated target risk control model, the training module 33 is further configured to: process an on-line service request based on the updated target risk control model to obtain a target risky service request for the upstream service node; and generate second training sample data based on the target risky service request.

The obtaining module 31, the generating module 32, and the training module 33 are connected in sequence. The service request processing apparatus 3 provided in this embodiment can implement the technical solutions of the foregoing method embodiments, and the implementation principles and technical effects thereof are similar and thus are not repeated in this embodiment.

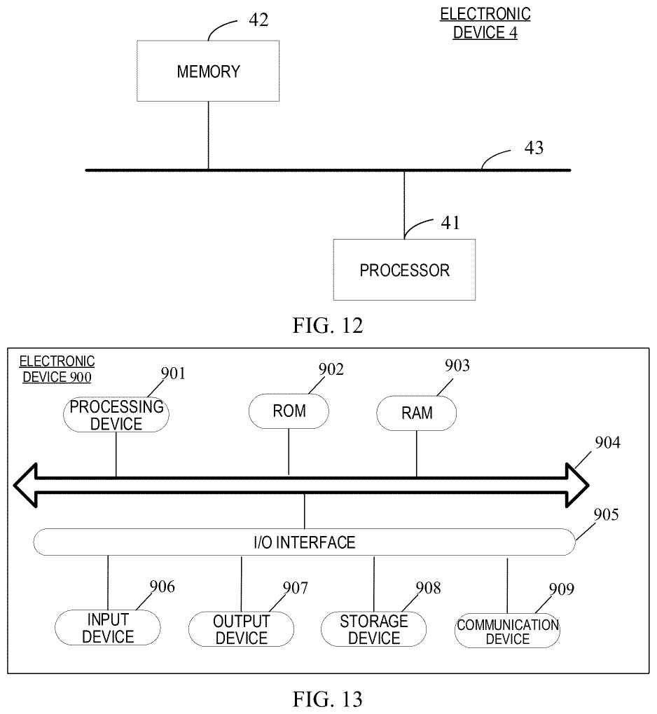

FIG. 12 is a schematic structural diagram of an electronic device according to an embodiment of the present disclosure. As shown in FIG. 12, the electronic device 4 comprises:
a processor 41, and a memory 42 that is in communication connection with the processor 41;
wherein the memory 42 stores computer-executed instructions;
the processor 41 executes the computer-executed instructions stored in the memory 42, so as to implement the method of service request processing in the embodiments shown in FIG. 2 to FIG. 10.

Optionally, the processor 41 and the memory 42 are connected via a bus 43.

The related descriptions can be understood with reference to the related descriptions and effects corresponding to the steps in the embodiments corresponding to FIG. 2 to FIG. 10, and are not repeated herein.

With reference to FIG. 13, this figure is a structural schematic diagram of an electronic device 900 capable to implement the embodiments of the present disclosure. The electronic device 900 may be a terminal device or a server. The terminal device may include, without limitation to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal) and the like, and a fixed terminal such as digital TV, a desktop computer and the like. The electronic device shown in FIG. 13 is merely an example and should not be construed as bringing any restriction on the functionality and usage scope of the embodiments of the present disclosure.

As shown in FIG. 13, the electronic device 900 may comprises a processing device (e.g., a central processor, a graphics processor) 901 which is capable of performing various appropriate actions and processes in accordance with programs stored in a read only memory (ROM) 902 or programs loaded from a storage device 908 to a random access memory (RAM) 903. In the RAM 903, there are also stored various programs and data required by the electronic device 900 when operating. The processing device 901, the ROM 902 and the RAM 903 are connected to one another via a bus 904. An input/output (I/O) interface 905 is also connected to the bus 1904.

Usually, the following devices may be connected to the I/O interface 905: an input device 906 including a touch screen, a touch pad, a keyboard, a mouse, a camera, a microphone, an accelerometers, a gyroscope, or the like; an output device 907, such as a liquid-crystal display (LCD), a loudspeaker, a vibrator, or the like; a storage device 908, such as a magnetic tape, a hard disk or the like; and a communication device 909. The communication device 909 allows the electronic device to perform wireless or wired communication with other device so as to exchange data with other device. While FIG. 13 shows the electronic device 900 with various devices, it should be understood that it is not required to implement or have all of the illustrated devices. Alternatively, more or less devices may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication device 909, or installed from the storage device 908, or installed from the ROM 902. The computer program, when executed by the processing device 901, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

The above computer-readable medium may be included in the above-mentioned electronic device; and it may also exist alone without being assembled into the electronic device.

The computer-readable medium carries one or more programs which, when executed by the electronic device, cause the electronic device to perform the method described in the foregoing embodiments.

Computer program codes for carrying out operations of the present disclosure may be written in one or more programming languages, including without limitation to, an object oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware. The name of a unit does not form any limitation to the module per se. For example, the first obtaining unit may further be described as a “unit for obtaining at least two Internet Protocol addresses.”

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In a first aspect, according to one or more embodiments of the present disclosure, a method of service request processing is provided, comprising:
obtaining user feedback data for a target service, wherein the target service is triggered based on a corresponding service request link, the service request link comprises a downstream service node and an upstream service node, the downstream service node characterizes the target service, the upstream service node characterizes a preceding service of a target service, and the user feedback data indicates the risk of a first service request for the downstream service node;
generating a first training sample based on the user feedback data, the first training sample comprising a second service request corresponding to the first service request, the second service request being a service request for the upstream service node; and performing on-line training on a target risk control model based on the first training sample to obtain an updated target risk control model, wherein the target risk control model identifies a risky service request for the upstream service node.

According to one or embodiments of the present disclosure, training a target risk control model based on the first training sample to obtain an updated target risk control model comprises: preprocessing the first training sample to obtain a first data factor set, the first data factor set characterizing at least one service feature of the second service request; and training a target risk control model based on the first data factor set to obtain an updated target risk control model.

According to one or embodiments of the present disclosure, pre-processing the first training samples to obtain a first data factor set comprises: obtaining a first service request corresponding to the user feedback data; performing feature extraction on at least one second service request corresponding to the first service request to obtain a corresponding target service feature set, the target service feature set being a set of service features of the respective second service requests; determining a weighting coefficient set corresponding to the target service feature set, wherein the weighting coefficient set characterizes a weighting coefficient corresponding to at least one service feature in the target service feature set; and generating the first data factor set according to the target service feature set and the corresponding weighting coefficient set.

According to one or embodiments of the present disclosure, determining a weighting coefficient set corresponding to the target service feature set comprises: obtaining a plurality of first historical service requests for the downstream service node by means of the user feedback data; obtaining at least one first service feature corresponding to the respective first historical service requests, and determining a confidence weight of the first historical service request according to the number of occurrences of the respective first service feature; determining, according to the confidence weight of the first historical service request, a weighting coefficient corresponding to a second service feature of the second service request corresponding to the first historical service request; and determining a weighting coefficient set corresponding to the target service feature set according to the weighting coefficient corresponding to the second service feature.

According to one or embodiments of the present disclosure, determining a confidence weight of the first historical service request according to the number of occurrences of the respective first service feature comprises: obtaining a first quantity and a second quantity, wherein the first quantity characterizes a total number of features of the respective first service features corresponding to the user feedback data; the second quantity characterizes a cumulative sum of the number of respective first service features corresponding to the first historical service request which recur among respective first service features corresponding to the user feedback data; and determining a confidence weight of the first historical service request according to a proportional relationship between the second quantity and the first quantity.

According to one or embodiments of the present disclosure, the user feedback data comprises complaint data and appeal data, wherein the complaint data indicates a risky service request for the downstream service node, and the appeal data indicates a legal service request for the downstream service node; the weighting coefficient set comprises a positive weighting coefficient and a negative weighting coefficient, the negative weighting coefficient being generated based on the appeal data, and the positive weighting coefficient being generated based on the complaint data.

According to one or embodiments of the present disclosure, generating the first data factor set according to the target service feature set and the corresponding weighting coefficient set comprises: obtaining training configuration information, the training configuration information being a weighting coefficient with respect to a service feature corresponding to the second service request in a training sample in a training process of the target risk control model; performing weighted fusion on training weights of corresponding risky service features in the training configuration information based on the target service feature set and the corresponding weighting coefficient set to obtain a first data factor set, and updating the training configuration information with the first data factor set.

According to one or embodiments of the present disclosure, the method further comprises: obtaining second training sample data, the second training sample being a risky service request for an upstream service node generated based on an online service request; pre-processing the second training samples to obtain a second data factor set, the second data factor set characterizing at least one service feature of a risky service request corresponding to the second training sample data; mixing the first data factor set and the second data factor set according to a preset proportional coefficient to obtain a mixed data factor set; wherein training a target risk control model based on the first data factor set to obtain an updated target risk control model comprises: training the target risk control model based on the mixed data factor set to obtain the updated target risk control model.

According to one or embodiments of the present disclosure, after performing on-line training on a target risk control model based on the first training samples to obtain an updated target risk control model, the method further comprises: processing an on-line service request based on the updated target risk control model to obtain a target risky service request for the upstream service node; and generating second training sample data based on the target risky service request.

In a second aspect, according to one or more embodiments of the present disclosure, a service request processing apparatus is provided, comprising:
an obtaining module, configured to obtain user feedback data for a target service, wherein the target service is triggered based on a corresponding service request link, the service request link comprises a downstream service node and an upstream service node, the downstream service node characterizes the target service, the upstream service node characterizes a preceding service of a target service, and the user feedback data indicates the risk of a first service request for the downstream service node;
a generating module, configured to generate a first training sample based on the user feedback data, the first training sample comprising a second service request corresponding to the first service request, the second service request being a service request for the upstream service node; and
a training module, configured to perform on-line training on a target risk control model based on the first training sample to obtain an updated target risk control model, wherein the target risk control model identifies a risky service request for the upstream service node.

According to one or embodiments of the present disclosure, the training module is specifically configured to: preprocess the first training sample to obtain a first data factor set, the first data factor set characterizing at least one service feature of the second service request; and train a target risk control model based on the first data factor set to obtain an updated target risk control model.

According to one or embodiments of the present disclosure, when pre-processing the first training samples to obtain a first data factor set, the training module is specifically configured to: obtain a first service request corresponding to the user feedback data; perform feature extraction on at least one second service request corresponding to the first service request to obtain a corresponding target service feature set, the target service feature set being a set of service features of the respective second service requests; determine a weighting coefficient set corresponding to the target service feature set, wherein the weighting coefficient set characterizes a weighting coefficient corresponding to at least one service feature in the target service feature set; and generate the first data factor set according to the target service feature set and the corresponding weighting coefficient set.

According to one or embodiments of the present disclosure, when determining a weighting coefficient set corresponding to the target service feature set, the training module is specifically configured to: obtain a plurality of first historical service requests for the downstream service node by means of the user feedback data; obtain at least one first service feature corresponding to the respective first historical service requests, and determine a confidence weight of the first historical service request according to the number of occurrences of the respective first service feature; determine, according to the confidence weight of the first historical service request, a weighting coefficient corresponding to a second service feature of the second service request corresponding to the first historical service request; and determine a weighting coefficient set corresponding to the target service feature set according to the weighting coefficient corresponding to the second service feature.

According to one or embodiments of the present disclosure, when determining a confidence weight of the first historical service request according to the number of occurrences of the respective first service feature, the training module is specifically configured to: obtain a first quantity and a second quantity, wherein the first quantity characterizes a total number of features of the respective first service features corresponding to the user feedback data; the second quantity characterizes a cumulative sum of the number of respective first service features corresponding to the first historical service request which recur among respective first service features corresponding to the user feedback data; determine a confidence weight of the first historical service request according to a proportional relationship between the second quantity and the first quantity.

According to one or embodiments of the present disclosure, the user feedback data comprises complaint data and appeal data, wherein the complaint data indicates a risky service request for the downstream service node, and the appeal data indicates a legal service request for the downstream service node; the weighting coefficient set comprises a positive weighting coefficient and a negative weighting coefficient, the negative weighting coefficient being generated based on the appeal data, and the positive weighting coefficient being generated based on the complaint data.

According to one or embodiments of the present disclosure, when generating the first data factor set according to the target service feature set and the corresponding weighting coefficient set, the training module is specifically configured to: obtain training configuration information, the training configuration information being a weighting coefficient with respect to a service feature corresponding to the second service request in a training sample in a training process of the target risk control model; perform weighted fusion on training weights of corresponding risky service features in the training configuration information based on the target service feature set and the corresponding weighting coefficient set to obtain a first data factor set, and update the training configuration information with the first data factor set.

In an embodiment of the present disclosure, the generating module is further configured to: obtain second training sample data, the second training sample being a risky service request for an upstream service node generated based on an online service request; the training module 33 is further configured to: pre-process the second training samples to obtain a second data factor set, the second data factor set characterizing at least one service feature of a risky service request corresponding to the second training sample data; mix the first data factor set and the second data factor set according to a preset proportional coefficient to obtain a mixed data factor set; when training a target risk control model based on the first data factor set to obtain an updated target risk control model, the training module is specifically configured to: train the target risk control model based on the mixed data factor set to obtain the updated target risk control model.

According to one or embodiments of the present disclosure, after performing on-line training on a target risk control model based on the first training samples to obtain an updated target risk control model, the training module is further configured to: process an on-line service request based on the updated target risk control model to obtain a target risky service request for the upstream service node; and generate second training sample data based on the target risky service request.

In a third aspect, according to one or more embodiments of the present disclosure, an electronic device is provided, comprising: a processor and a memory that is in communication connection with the processor; wherein
the memory stores computer-executed instructions;
the processor executes the computer-executed instructions stored in the memory so as to implement the method of service request processing according to the first aspect and various possible designs of the first aspect.

In a fourth aspect, according to one or more embodiments of the present disclosure, a computer-readable storage medium is provided, wherein the computer-readable storage medium stores computer-executed instructions which, when executed by a processor, implement the method of service request processing according to the first aspect and various possible designs of the first aspect.

In a fifth aspect, according to one or more embodiments of the present disclosure, a computer program product is provided, comprising a computer program, wherein the computer program, when executed by a processor, implements the method of service request processing according to the first aspect and various possible designs of the first aspect.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

1. A method of service request processing, comprising:
obtaining user feedback data for a target service, wherein the target service is triggered based on a corresponding service request link, the service request link comprises a downstream service node and an upstream service node, the downstream service node characterizes the target service, the upstream service node characterizes a preceding service of the target service, and the user feedback data indicates risk of a first service request for the downstream service node;
generating a first training sample based on the user feedback data, the first training sample comprising a second service request corresponding to the first service request, the second service request being a service request for the upstream service node; and
training a target risk control model based on the first training sample to obtain an updated target risk control model, wherein the target risk control model identifies a risky service request for the upstream service node.

2. The method of claim 1, wherein training the target risk control model based on the first training sample to obtain the updated target risk control model comprises:
preprocessing the first training sample to obtain a first data factor set, the first data factor set characterizing at least one service feature of the second service request; and
training a target risk control model based on the first data factor set to obtain an updated target risk control model.

3. The method of claim 2, wherein pre-processing the first training samples to obtain the first data factor set comprises:
obtaining a first service request corresponding to the user feedback data;
performing feature extraction on at least one second service request corresponding to the first service request to obtain a corresponding target service feature set, the target service feature set being a set of service features of the respective second service requests;
determining a weighting coefficient set corresponding to the target service feature set, wherein the weighting coefficient set characterizes a weighting coefficient corresponding to at least one service feature in the target service feature set; and
generating the first data factor set based on the target service feature set and the corresponding weighting coefficient set.

4. The method of claim 3, wherein determining the weighting coefficient set corresponding to the target service feature set comprises:
obtaining a plurality of first historical service requests for the downstream service node by means of the user feedback data;
obtaining at least one first service feature corresponding to the respective first historical service requests, and determining confidence weights of the first historical service requests based on the number of occurrences of each of the at least one first service feature;
determining, based on the confidence weights of the first historical service requests, a weighting coefficient corresponding to a second service feature of the second service request corresponding to the first historical service requests; and
determining a weighting coefficient set corresponding to the target service feature set based on the weighting coefficient corresponding to the second service feature.

5. The method of claim 4, wherein determining the confidence weights of the first historical service requests based on the number of occurrences of each of the at least one first service feature comprises:
obtaining a first quantity and a second quantity, wherein the first quantity characterizes a total number of features of first service features corresponding to the user feedback data; the second quantity characterizes a cumulative sum of the numbers of first service features corresponding to the first historical service requests which recur among respective first service features corresponding to the user feedback data; and
determining a confidence weight of the first historical service request based on a proportional relationship between the second quantity and the first quantity.

6. The method of claim 3, wherein the user feedback data comprises complaint data and appeal data, wherein the complaint data indicates a risky service request for the downstream service node, and the appeal data indicates a legal service request for the downstream service node; and
wherein the weighting coefficient set comprises a positive weighting coefficient and a negative weighting coefficient, the negative weighting coefficient is generated based on the appeal data, and the positive weighting coefficient is generated based on the complaint data.

7. The method of claim 3, wherein generating the first data factor set based on the target service feature set and the corresponding weighting coefficient set comprises:
obtaining training configuration information, the training configuration information being a weighting coefficient with respect to a service feature corresponding to the second service request in a training sample in a training process of the target risk control model; and
performing weighted fusion on training weights of corresponding risky service features in the training configuration information based on the target service feature set and the corresponding weighting coefficient set to obtain a first data factor set, and updating the training configuration information with the first data factor set.

8. The method of claim 2, further comprising:
obtaining second training sample data, the second training sample being a risky service request for an upstream service node generated based on an online service request;
preprocessing the second training samples to obtain a second data factor set, the second data factor set characterizing at least one service feature of a risky service request corresponding to the second training sample data; and
mixing the first data factor set and the second data factor set based on a preset proportional coefficient to obtain a mixed data factor set; and
wherein training the target risk control model based on the first data factor set to obtain an updated target risk control model comprises:
training the target risk control model based on the mixed data factor set to obtain the updated target risk control model.

9. The method of claim 1, wherein after training a target risk control model based on the first training sample to obtain an updated target risk control model, the method further comprises:
processing an on-line service request based on the updated target risk control model to obtain a target risky service request for the upstream service node; and
generating second training sample data based on the target risky service request.

10. (canceled)

11. An electronic device, comprising: a processor and a memory that is in communication connection with the processor; wherein
the memory stores computer-executed instructions;
the processor executes the computer-executed instructions stored in the memory so as to implement acts comprising:
obtaining user feedback data for a target service, wherein the target service is triggered based on a corresponding service request link, the service request link comprises a downstream service node and an upstream service node, the downstream service node characterizes the target service, the upstream service node characterizes a preceding service of the target service, and the user feedback data indicates risk of a first service request for the downstream service node;
generating a first training sample based on the user feedback data, the first training sample comprising a second service request corresponding to the first service request, the second service request being a service request for the upstream service node; and
training a target risk control model based on the first training sample to obtain an updated target risk control model, wherein the target risk control model identifies a risky service request for the upstream service node.

12-13. (canceled)

14. The device of claim 11, wherein training the target risk control model based on the first training sample to obtain the updated target risk control model comprises:
preprocessing the first training sample to obtain a first data factor set, the first data factor set characterizing at least one service feature of the second service request; and
training a target risk control model based on the first data factor set to obtain an updated target risk control model.

15. The device of claim 14, wherein pre-processing the first training samples to obtain the first data factor set comprises:
obtaining a first service request corresponding to the user feedback data;
performing feature extraction on at least one second service request corresponding to the first service request to obtain a corresponding target service feature set, the target service feature set being a set of service features of the respective second service requests;
determining a weighting coefficient set corresponding to the target service feature set, wherein the weighting coefficient set characterizes a weighting coefficient corresponding to at least one service feature in the target service feature set; and
generating the first data factor set based on the target service feature set and the corresponding weighting coefficient set.

16. The device of claim 15, wherein determining the weighting coefficient set corresponding to the target service feature set comprises:
obtaining a plurality of first historical service requests for the downstream service node by means of the user feedback data;
obtaining at least one first service feature corresponding to the respective first historical service requests, and determining confidence weights of the first historical service requests based on the number of occurrences of each of the at least one first service feature;
determining, based on the confidence weights of the first historical service requests, a weighting coefficient corresponding to a second service feature of the second service request corresponding to the first historical service requests; and
determining a weighting coefficient set corresponding to the target service feature set based on the weighting coefficient corresponding to the second service feature.

17. The device of claim 16, wherein determining the confidence weights of the first historical service requests based on the number of occurrences of each of the at least one first service feature comprises:
obtaining a first quantity and a second quantity, wherein the first quantity characterizes a total number of features of first service features corresponding to the user feedback data; the second quantity characterizes a cumulative sum of the numbers of first service features corresponding to the first historical service requests which recur among respective first service features corresponding to the user feedback data; and
determining a confidence weight of the first historical service request based on a proportional relationship between the second quantity and the first quantity.

18. The device of claim 15, wherein the user feedback data comprises complaint data and appeal data, wherein the complaint data indicates a risky service request for the downstream service node, and the appeal data indicates a legal service request for the downstream service node; and
wherein the weighting coefficient set comprises a positive weighting coefficient and a negative weighting coefficient, the negative weighting coefficient is generated based on the appeal data, and the positive weighting coefficient is generated based on the complaint data.

19. The device of claim 15, wherein generating the first data factor set based on the target service feature set and the corresponding weighting coefficient set comprises:
obtaining training configuration information, the training configuration information being a weighting coefficient with respect to a service feature corresponding to the second service request in a training sample in a training process of the target risk control model; and
performing weighted fusion on training weights of corresponding risky service features in the training configuration information based on the target service feature set and the corresponding weighting coefficient set to obtain a first data factor set, and updating the training configuration information with the first data factor set.

20. The device of claim 14, wherein the acts further comprise:
obtaining second training sample data, the second training sample being a risky service request for an upstream service node generated based on an online service request;
preprocessing the second training samples to obtain a second data factor set, the second data factor set characterizing at least one service feature of a risky service request corresponding to the second training sample data; and
mixing the first data factor set and the second data factor set based on a preset proportional coefficient to obtain a mixed data factor set; and
wherein training the target risk control model based on the first data factor set to obtain an updated target risk control model comprises:
training the target risk control model based on the mixed data factor set to obtain the updated target risk control model.

21. The device of claim 11, wherein after training a target risk control model based on the first training sample to obtain an updated target risk control model, the acts further comprise:
processing an on-line service request based on the updated target risk control model to obtain a target risky service request for the upstream service node; and
generating second training sample data based on the target risky service request.

22. A non-transitory computer-readable storage medium, wherein the computer-readable storage medium stores computer-executed instructions which, when executed by a processor, implement acts comprising:
obtaining user feedback data for a target service, wherein the target service is triggered based on a corresponding service request link, the service request link comprises a downstream service node and an upstream service node, the downstream service node characterizes the target service, the upstream service node characterizes a preceding service of the target service, and the user feedback data indicates risk of a first service request for the downstream service node;
generating a first training sample based on the user feedback data, the first training sample comprising a second service request corresponding to the first service request, the second service request being a service request for the upstream service node; and
training a target risk control model based on the first training sample to obtain an updated target risk control model, wherein the target risk control model identifies a risky service request for the upstream service node.

23. The non-transitory computer-readable storage medium of claim 22, wherein training the target risk control model based on the first training sample to obtain the updated target risk control model comprises:
preprocessing the first training sample to obtain a first data factor set, the first data factor set characterizing at least one service feature of the second service request; and
training a target risk control model based on the first data factor set to obtain an updated target risk control model.
